(19) United States
(12) Patent Application Publication
(10) Pub. No.: US 2007/0183510 A1
(43) Pub. Date: Aug. 9, 2007

(54) METHOD AND APPARATUS FOR DECODING VIDEO THAT ALTERNATELY STORE LINES OF PICTURE IN PIXEL UNITS AND METHOD OF STORING REFERENCE PICTURE

(76) Inventors: Nak-hee Seong, Gwacheon-si (KR); Jae-hong Park, Seongnam-si (KR); Young-jun Kwon, Seongnam-si (KR); Tae-sun Kim, Yongin-si (KR); Seon-young Yeo, Seoul (KR); Sang-hoon Lee, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/622,498

(22) Filed: Jan. 12, 2007

(30) Foreign Application Priority Data
Jan. 13, 2006 (KR) 10-2006-0003957

(51) Int. Cl. H04N 11/02

(52) U.S. Cl. 375/240.25

(57) ABSTRACT

A method and apparatus for decoding video, which alternately store lines of a picture in pixel units, and a method of storing a reference picture, n which the apparatus includes a memory that stores M lines of a picture in N interleave lines, wherein M is a natural number and N is a natural number smaller than M, and a decoder that decodes the picture by receiving the interleave lines, wherein pixel data of a part of the lines from among the M lines is alternately stored in each interleave line. Using the method and apparatus for decoding a video and the method of storing a reference picture, the decoding speed can be increased and latency during decoding of a video and a bandwidth can be decreased,

### CROSS-REFERENCE TO RELATED PATENT APPLICATION

This application claims the benefit of Korean Patent Application No. 10-2006-0003957, filed on Jan. 13, 2006, in the Korean Intellectual Property Office, the disclosure of which is incorporated herein in its entirety by reference,

### BACKGROUND OF THE INVENTION

1. Technical Field

The present disclosure relates to an apparatus for decoding a video and, more particularly, to a method and apparatus for decoding video, which alternately store lines of a picture in pixel units, and a method of storing a reference picture.

2. Discussion of Related Art

When a conventional video displays video stream data, the conventional video uses a method of compensating for motion using a reference picture. That is, the conventional video stores the reference picture in a memory, reads the stored reference picture in a block form having a requested size, decodes the read-out reference picture, and performs motion compensation.

The conventional video stores the reference picture in line units in the memory. Accordingly, in order to decode the reference picture, the conventional video reads the reference picture in line units. In this case, when the number of lines that are to be read increases, the bandwidth employed while decoding the reference picture increases remarkably.

More specifically, while decoding a video, the reading of the reference picture from the memory uses most of the bandwidth. Accordingly, in order to reduce the bandwidth, the number of lines that are to be read should be decreased.

### SUMMARY OF THE INVENTION

Exemplary embodiments of the present invention provide a method and apparatus for decoding video, which alternately store lines of a picture in pixel units.

Exemplary embodiments of the present invention provide a method of storing a reference picture, which alternately stores lines of the reference picture in pixel units.

According to an exemplary embodiment of the present invention, there is provided an apparatus for decoding video, the apparatus comprising, a memory that stores M lines of a picture in N interleave lines, wherein M is a natural number and N is a natural number smaller than M; and a decoder that decodes the picture by receiving the interleave lines, wherein pixel data of a part of the lines from among the M lines is alternately stored in each interleave line.

According to an exemplary embodiment of the present invention, there is provided a method of decoding a picture in a video decoding system having a memory, the method comprising: storing M lines of the picture in N interleave lines, wherein M is a natural number and N is a natural number smaller than M, and decoding the picture by receiving the interleave lines, wherein pixel data of a part of the lines from among the M lines is alternately stored in each interleave line.

According to an exemplary embodiment of the present invention, there is provided a method of storing a reference picture, the method comprising: classifying M lines of the reference picture into N groups, wherein M is a natural number and N is a natural number smaller than N, and storing the lines belonging to the N groups as N interleave lines, wherein pixel data of a part of the lines from among the M lines is alternately stored in each interleave line.

### BRIEF DESCRIPTION OF THE DRAWINGS

Exemplary embodiments of the present invention will be understood in more detail from the following descriptions taken in conjunction with the attached drawings, in which;

FIG. 1 is a block diagram illustrating a video system including an apparatus for decoding video according to an exemplary embodiment of the present invention;

FIG. 2 is a diagram illustrating a reference picture including a plurality of lines, and

FIG. 3 illustrates how the lines of the reference picture illustrated in FIG. 2 are alternately stored in a memory of an apparatus for decoding video in pixel units according to an exemplary embodiment of the present invention.

### DETAILED DESCRIPTION OF EXEMPLARY EMBODIMENTS

Hereinafter, the present invention will be described more fully with reference to the accompanying drawings, in which exemplary embodiments of the present invention are shown. In the drawings, like reference numerals denote like elements.

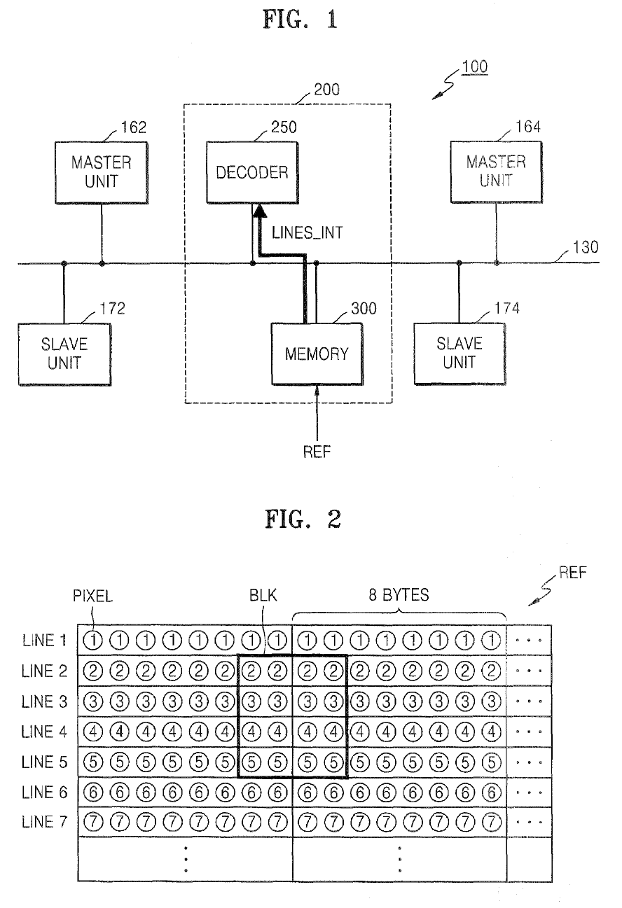

FIG. 1 is a block diagram illustrating a video system 100 including an apparatus 200 for decoding video according to an exemplary embodiment of the present invention.

Referring to FIG. 1, the video system 100 includes the apparatus 200 for decoding videos master units 162 and 164, slave units 172 and 174, and a system bus 130. The apparatus 200, the master units 162 and 164, and the slave units 172 and 174 transmit/receive data through the system bus 130.

The apparatus 200 includes a memory 300 and a decoder 250. The memory 300 stores M lines of a picture REF as N interleave lines LINES_INT, wherein M is a natural number and N is a natural number smaller than M. In each interleave line, pixel data of a part of the lines from among the M lines is alternately stored. The decoder 250 receives the interleave lines LINES_INT in order to decode the picture REF.

The pixel data of the part of the lines may be alternately stored in each interleave line LINES_INT in pixel units.

The memory 300 included in the apparatus 200 according to the exemplary embodiment of the present invention may be a dynamic random access memory (DRAM).

FIG. 2 is a diagram illustrating a reference picture REF including a plurality of lines LINE1 through LINE7.

Referring to FIG. 2, 7 lines LINE1 through LINE7 of the reference picture REF are illustrated, and pixels of 16 bytes of each of the lines LINE1 through LINE7 are illustrated. The number of lines of the reference picture REF and the number of bytes of pixels in the lines LINE1 through LINE7, however, are not limited to the number shown.

In FIG. 2, an example of a read block BLK, which is the units in which the reference picture REF is read, is illustrated. That is, the read block BLK is a 4×4 block. The read block BLK includes 4 lines LINE2 through LINE5 and pixels of 16 bytes.

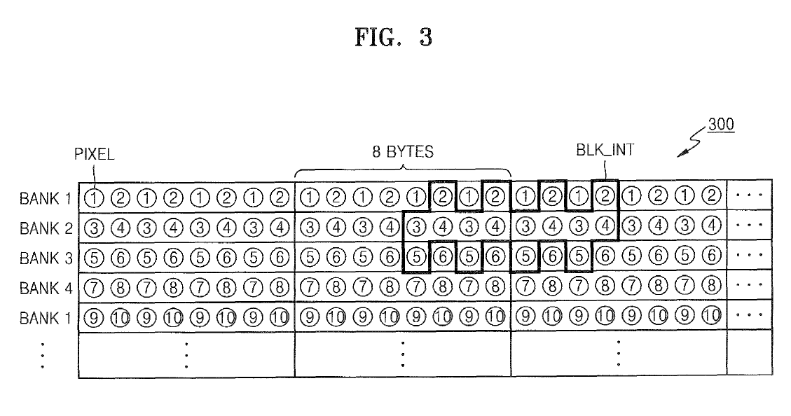

FIG. 3 illustrates how the lines LINE1 through LINE7 of the reference picture REF illustrated in FIG. 2 are alternately stored in the memory 300 of the apparatus 200 for decoding a video in pixel units, according to an exemplary embodiment of the present invention.

Hereinafter, processes of an apparatus 200 for decoding video storing and decoding a reference picture will be described with reference to FIGS. 1 through 3.

The apparatus 200 according to the exemplary embodiment stores M lines of the reference picture as N interleave lines, wherein M is a natural number and N is a natural number smaller than M. Pixel data of a part of the lines from among the M lines is alternately stored in pixel units in each interleave line. For example., the apparatus 200 divides and stores the lines LINE1 through LINE7 of the reference picture illustrated in FIG. 2 as 4 interleave lines.

The memory 300 stores one interleave line in one bank of the memory 300. For example, the memory 300 stores an interleave line, in which pixel data of lines LINE1 and LINE2 is alternately stored, in a first bank BANK1. Also, the memory 300 stores an interleave line in which pixel data of lines LINE3 and LINE4 is alternately stored, in a second bank BANK2.

Referring to FIGS. 2 and 3, a reference picture block BLK illustrated in S FIG. 2 is stored in the memory 300 in an interleave block BLK_INT form illustrated in FIG. 3 in the apparatus 200 according to the exemplary embodiment. Pixel data included in the reference picture block BLK illustrated in FIG. 2 and pixel data included in the interleave block BLK_INT illustrated in FIG. 3 are the same.

When the pixel data of the reference picture block BLK is to be used, a conventional video should read 4 lines. A decoder 250 of the apparatus 200 according to the exemplary embodiment, however, reads only 3 lines when the pixel data of the interleave block BLK_INT illustrated in FIG. 3 is to be used. Accordingly, the speed of decoding the reference picture can be increased, is Also, latency while decoding the reference picture can be decreased, and bandwidth can be decreased.

More specifically, when the reference picture block BLK illustrated in FIG. 2 and the interleave block BLK_INT illustrated in FIG. 3 are not arranged according to a data read unit of the memory 300, the apparatus 200 according to the exemplary embodiment has a faster decoding speed compared to that of conventional video.

For example, the reference picture block BLK illustrated in FIG. 2 and the interleave block BLK_INT illustrated in FIG. 3 are blocks that are not each arranged at divisions of 8 bytes in the memory. Accordingly, when the pixel data of the reference picture block BLK illustrated in FIG. 2 is to be used, the conventional video reads pixel data of 64 bytes (16 bytes×4 lines) from the memory. On the other hand, when the pixel data of the interleave block BLK_INT illustrated in FIG. 3 is to be used, the apparatus 200 according to the exemplary embodiment of the present invention reads pixel data of 48 bytes (16 bytes×3 lines) from the memory 300. That is, the apparatus 200 reads a relatively small number of pixel data compared to the conventional video.

According to a method of decoding video of an exemplary embodiment of the present invention a picture is decoded in a video decoding system including a memory. The method includes storing M lines of the picture as N interleave lines wherein M is a natural number and N is a natural number smaller than M, and decoding the picture by receiving the interleave lines. Pixel data of a part of the lines from among the M lines is alternately stored in each interleave line.

The pixel data of the part of the lines may be alternately stored in each interleave line in pixel units,

In the storing as interleave lines, one interleave line may be stored in one bank of the memory.

Also in the storing as interleave lines, two lines of the picture may be stored as one interleave line, and pixel data of the two lines may be alternately stored in the one interleave line.

A method of storing a reference picture according to an exemplary embodiment of the present invention includes classifying M lines of the reference picture into N groups, wherein M is a natural number and N is a natural number smaller than N and storing the lines belonging to the N groups as N interleave lines. Pixel data of a part of the lines from among the M lines is alternately stored in each interleave line.

The pixel data of the part of lines may be stored in each interleave line in pixel units.

In the storing as interleave lines, two lines of the reference picture may be stored as one interleave line, and pixel data of the two lines may be alternately stored in the one interleave line.

Technical aspects of the method of decoding video and the method of storing a reference picture are identical to the technical aspect of the apparatus for decoding video described above, and operations of both methods correspond to operations of the apparatus for decoding a video. Accordingly, one of ordinary skill in the art can easily understand the methods of decoding a video and of storing a reference picture with reference to the description of the apparatus for decoding a video, and thus detailed descriptions of the methods will be omitted.

According to the apparatus and method of decoding video and the method of storing a reference picture of the exemplary embodiment of the present invention, the speed of decoding a picture can be increased. Also, latency white decoding a picture can be decreased, and bandwidth can be decreased.

While the present invention has been particularly shown and described with reference to exemplary embodiments thereof it will be understood by those of ordinary skill in the art that various changes in form and details may be made therein without departing from the spirit and scope of the present invention, as defined by the following claims.

What is claimed is:

1. An apparatus for decoding video the apparatus comprising:
a memory that stores M lines of a picture in N interleave lines, wherein M is a natural number and N is a natural number smaller than M; and
a decoder that decodes the picture by receiving the interleave lines,
wherein pixel data of a part of the lines from among the M lines is alternately stored in each interleave line.

2. The apparatus of claim 1, wherein the pixel data of the part of the lines from among the M lines is alternately stored in each interleave line in pixel units.

3. The apparatus of claim 2, wherein the memory stores one interleave line in one bank of the memory.

4. The apparatus of claim 1, wherein the memory stores two lines as one interleave line, and pixel data of the two lines is alternately stored in the one interleave line.

5. The apparatus of claim 4, wherein the pixel data of the two lines is alternately stored in the one interleave line in pixel units.

6. The apparatus of claim 1, wherein the picture is a reference picture.

7. The apparatus of claim 1, wherein the memory is a dynamic random access memory (DRAM).

8. The apparatus of claim 2, wherein the picture is a reference picture.

9. The apparatus of claim 3, wherein the picture is a reference picture.

10. The apparatus of claim 4, wherein the picture is a reference picture.

11. The apparatus of claim 5, wherein the picture is a reference picture.

12. A method of decoding a picture in a video decoding system including a memory the method comprising:
storing M lines of the picture in N interleave lines in the memory, wherein M is a natural number and N is a natural number smaller than M; and
decoding the picture by receiving the interleave lines,
wherein pixel data of a part of the lines from among the M lines is alternately stored in each interleave line.

13. The method of claim 12, wherein the pixel data of the part of the lines is alternately stored in each interleave sine in pixel units.

14. The method of claim 13, wherein one interleave line is stored in one bank of the memory.

15. The method of claim 12, wherein two lines of the picture are stored as one interleave line, and pixel data of the two lines is alternately stored in the one interleave line.

16. The method of claim 15, wherein the pixel data of the two lines is alternately stored in the one interleave line in pixel units.

17. The method of claim 12, wherein the picture is a reference picture.

18. The method of claim 13, wherein the picture is a reference picture.

19. The method of claim 14, wherein the picture is a reference picture,

20. The method of claim 15, wherein the picture is a reference picture.

21. The method of claim 16, wherein the picture is a reference picture.

22. A method of storing a reference picture, the method comprising:
classifying M lines of the reference picture into N groups, wherein M is a natural number and N is a natural number smaller than N; and
storing the lines belonging to the N groups as N interleave lines,
wherein pixel data of a part of the lines from among the M lines is alternately stored in each interleave line.

23. The method of claim 22, wherein the pixel data of a part of the lines from among the M lines is alternately stored in each interleave line in pixel units.

24. The method of claim 22, wherein one interleave line is stored in one bank of the memory.

25. The method of claim 22, wherein two lines of the reference picture are stored as one interleave line, and pixel data of the two lines is alternately stored in the one interleave line.

26. The method of claim 25, wherein the pixel data of the two lines is alternately stored in the one interleave line in pixel units.
